(19) United States
(12) Patent Application Publication
(10) Pub. No.: US 2011/0089661 A1
(43) Pub. Date: Apr. 21, 2011

(54) Bicycle Axle Assembly

(76) Inventor: Reiner Künstle, Metzingen (DE)

(21) Appl. No.: 12/972,003

(22) Filed: Dec. 17, 2010

Related U.S. Application Data
(63) Continuation-in-part of application No. PCT/EP2009/004378, filed on Jun. 17, 2009.

(30) Foreign Application Priority Data
Jun. 19, 2008 (DE) 10 2008 029 135.8

(51) Int. Cl. B62K 19/30; B60B 35/04

(52) U.S. Cl. 280/281.1; 301/124.2

(57) ABSTRACT

The invention relates to a bicycle axle assembly comprising an axle formed as a carrier part for a hub, a clamping device for clamping the bicycle axle assembly in a bicycle wheel axle holder, and a stop device formed to secure the axle of the bicycle axle assembly in the axial direction in the clamped state of the clamping device. The stop device has a stop member that comprises a stop of the stop device. The stop is springy in the radial direction. The bicycle axle assembly is formed such that the stop, which is springy in the radial direction, secures the axle in the axial direction in the clamped state of the clamping device and releases the axle in the axial direction in the released state of the clamping device.

### CROSS-REFERENCE TO RELATED APPLICATIONS

This is a continuation-in-part application, under 35 U.S.C. §120, of copending international application No. PCT/EP2009/004378, filed Jun. 17, 2009, which designated the United States and was published in English; this application also claims the priority, under 35 U.S.C. §119, of German Patent Application No. 10 2008 029 135.8, filed Jun. 19, 2008; the prior applications are herewith incorporated by reference in their entirety.

### STATEMENT REGARDING FEDERALLY SPONSORED RESEARCH OR DEVELOPMENT

Not applicable.

### FIELD OF THE INVENTION

The invention relates to a bicycle axle assembly. The invention also relates to a combination of a bicycle wheel axle holder, such as a bicycle fork, a bicycle rocker arm, a bicycle chainstay or another wheel holder having such a bicycle axle assembly.

Such bicycle axle assemblies are known and are used in particular in the case of bicycles with forks for downhill (DH), cross-country (CC), and freeride/freestyle (FR) use. In such uses, due to high speeds, considerable unevenness, large jumps and the necessity of overcoming obstacles, the bicycle axle assembly is subjected to particularly high loads.

In the case of fast-action clamping devices for full-floating axles, it is necessary reliably to prevent the running wheel from falling out if clamping levers are opened accidentally. For this purpose, as a rule, closed holder ends on the bicycle wheel holder (fork, rocker arm, chainstay, etc) are provided. In the case of bicycle forks, the holder ends are also referred to as dropouts.

The invention provides a bicycle axle assembly in which the mounting and dismantling can be carried out easily, rapidly and reliably and, at the same time, high operational safety and stability are ensured, particularly for cross-country riding.

Objectives of the invention are achieved by a bicycle axle assembly having an axle formed as a carrier part for a hub, a clamping device for clamping the bicycle axle assembly in a bicycle wheel holder, and a stop device formed such that, in the clamped state of the clamping device, it secures the axle of the bicycle axle assembly in the axial direction. The stop device has a stop member which comprises a stop of the stop device, which stop is springy in the radial direction. The bicycle axle assembly is formed such that this radially springy stop secures the axle in the axial direction in the clamped state of the clamping device and releases the axle in the axial direction in the released state of the clamping device.

According to the invention, the stop member of the stop device may comprise a slotted end section of the axle. The slotted end section of the axle may taper outwards relative to the axle. Furthermore, a collar extending radially outwards may be formed on that end of the slotted end section that is to the side relative to the axle.

According to the invention, the external diameter of the collar in the released state may be less than or equal to the external diameter of that section of the axle which is adjacent to the slotted end section.

According to the invention, that end section of the axle opposite the slotted end section may have a greater external diameter than the section adjacent to this end section. The greater external diameter can be achieved, for example, by a greater wall thickness of the axle in this region. Alternatively or additionally, the greater external diameter can be achieved by broadening. The embodiment of the invention having a greater external diameter can advantageously be used in combination with a bicycle wheel holder that has an open holder end for receiving this end section having a larger external diameter because securing to prevent falling out can be realized, for example, by providing a countersink in the open holder end.

According to the invention, the clamping device may have a clamping axle disposed coaxially with the axle.

According to the invention, the clamping device may be in the form of a fast-action clamping device.

According to the invention, the bicycle axle assembly may have a spring device that clamps the counter-holder away from the axle.

According to the invention, the bicycle axle assembly may have a counter-holder comprising a flange for support on a holder end of a bicycle wheel holder and an abutment region for the clamping device. The flange of the counter-holder may be disposed on the region opposite the slotted end section of the axle. Furthermore, the spring device may be a pressure spring disposed between the counter-holder and the axle.

According to the invention, the counter-holder may have a further flange disposed in the region of the slotted end section of the axle. The two flanges of the counter-holder can be connected to a section in which the clamping axle runs. Furthermore, the further flange can be disposed such that it widens the slotted end section of the axle in the clamped state of the clamping device.

According to the invention, the clamping device may have a nut disposed on the clamping axle and engages the slotted end section of the axle at least in the clamped state. The forced transmission between the nut and the slotted end section can occur directly or indirectly through a link connected in between. In this embodiment, the nut may have an external diameter tapering in the direction of the axle. On clamping, the nut moves into the slotted end section and widens the slotted end section until the collar projects beyond the external diameter of the axle and can engage the holder end of the bicycle wheel holder.

According to the invention, the stop member of the stop device may have a clamping element with a collar formed radially inwards. The axle may have an end section with a smaller external diameter, which is provided with a collar formed radially outwards and serving as a counter-stop for the collar of the stop member. Furthermore, the clamping device may have a link disposed and formed such that the link moves in the direction of the clamping element on clamping of the clamping device and moves the stop, which is springy in the radial direction, radially inwards. This embodiment has the advantage that the axle can be formed as a simple turned part. Moreover, a very short clamping axle can be provided, with the result that a lower weight can be achieved. The bicycle axle assembly may have a spring device that pre-stresses the link away from the clamping element.

According to the invention, the axle may be tubular.

According to the invention, the axle may be a full-floating axle.

According to the invention, the axle may have an end section with a greater diameter. This has the advantage that securing is possible in an open dropout.

According to the invention, the clamping axle is formed to be adjustable in length. This embodiment has the advantage that the clamping force of the clamping device is presettable if fast-action tension locks are used. In the other embodiments, presetting of the clamping force could be effected by suitable dimensioning of the components, which requires high accuracy in production. By adjusting the length of the clamping axle, it is possible to adjust the position from when the stop device grips the fast-action clamping device on clamping and builds up a clamping force. As a result of the adjustability of the length of the clamping axle, it is therefore possible that the clamping force of the fast-action clamping apparatus can be adjusted.

According to the invention, the clamping axle is formed in at least two parts.

According to the invention, the clamping axle may have an adjusting nut that is screwed onto an axle section of the clamping action, which in an exemplary embodiment has a threaded blind hole.

According to the invention, the clamping axle can be disposed to be non-rotatable relative to the axle.

According to the invention, the counter-holder can be disposed to be non-rotatable relative to the axle and/or the clamping axle.

According to the invention, the axle may have a rotation prevention section, and the clamping axle may have a rotation prevention section that cooperates with the rotation prevention section of the axle. The rotation prevention section of the axle may have a polygon socket and/or internal multi-tooth profile, and the rotation prevention section of the clamping axle may have an external polygon and/or external multi-tooth profile.

According to the invention, the bicycle axle assembly may have a hub, which is disposed on the axle, and a loss prevention device that disposes the axle in the hub in a captive manner, the loss prevention device in an exemplary embodiment is disposed in a cavity formed between the hub and the axle. The loss prevention device, in particular, is in an exemplary embodiment formed from one or more O-rings disposed on the axle.

According to the invention, the bicycle axle assembly may have a spring device that prestresses the axle in the direction of the fast-action clamping end of the axle. The spring device may be disposed between the hub and the loss prevention device.

According to the invention, a bicycle wheel axle holder having a bicycle axle assembly according to the invention and two holder ends for receiving the axle is also provided, one holder end being in the form of a closed holder end and the other holder end being in the form of an open holder end. The closed dropout (and/or the open dropout) may have a stop for the hub of the running wheel. Furthermore, the open dropout (and/or the closed dropout) may have a countersink. Furthermore, the bicycle wheel axle holder may be part of a bicycle fork, part of a bicycle rocker arm and/or part of a bicycle chainstay.

These embodiments have the advantage that a defined position is permitted on installation of the wheel in the bicycle axle holder, with the result that installation of the running wheel is possible with one hand so that the other hand can hold the bicycle.

Advantageously, the stop device can be disposed and formed such that the clamping force exerted by the fast-action clamping device is presettable. The presetting of the clamping force can be effected by adjusting the relative position of the stops of the stop device in the direction of the axle. This can be effected during production. Alternatively and in an exemplary embodiment, the length of the clamping axle is adjustable such that the position of the stop provided on the clamping axle, and hence the clamping force, are adjustable. For this purpose, the clamping axle may be formed, for example, at least in two parts. For example, the clamping axle may have an adjusting nut that is screwed onto a clamping axle section. The head of the adjusting nut may be in the form of a stop of the stop device, which stop cooperates with a corresponding axle stop of the axle. According to a further development of the invention, the adjusting nut may be a self-locking adjusting nut to prevent unintentional misadjustment. Alternatively, the adjusting nut may also be secured in its axial position by a lock nut.

Although the invention is illustrated and described herein as embodied in a bicycle axle assembly, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a cross-sectional view through a full-floating axle apparatus according to an exemplary embodiment of the invention in a clamped position.

FIG. 2 is a cross-sectional view of the axle apparatus of FIG. 1 in a released position.

FIG. 3 is a side elevational view of a full-floating axle of the axle apparatus of FIG. 1.

FIG. 4 is a perspective view of the full-floating axle of FIG. 3.

FIG. 5 is a side elevational view of a counter-holder of the axle apparatus of FIG. 1.

FIG. 6 is a perspective view of the counter-holder of FIG. 5.

FIG. 7 is a cross-sectional view of a full-floating axle apparatus along line VII-VII of FIG. 9 according to a further exemplary embodiment of the invention in a clamped position.

FIG. 8 is a cross-sectional view of the axle apparatus of FIG. 7 in a released position.

FIG. 9 is a front elevational view of the axle apparatus of FIG. 7 with a schematically illustrated bicycle fork in the clamped state.

FIG. 10a front elevational view of the axle apparatus of FIG. 7 corresponding to the configuration of FIG. 9 in an opened released state.

FIG. 11 is a cross-sectional view of a full-floating axle apparatus along line XI-XI of FIG. 15 according to a further exemplary embodiment in a clamped state.

FIG. 12 is a cross-sectional view of the axle apparatus of FIG. 11 along the line XII-XII of FIG. 16 in the released state.

FIG. 13 is a perspective view of a clamping element of the axle apparatus of FIG. 11.

FIG. 14 is a perspective view of the clamping axle of the axle apparatus of FIG. 11.

FIG. 15 is a front elevational view of the axle apparatus FIG. 11 with a schematically shown bicycle fork in the clamped state.

FIG. 16 is a front elevational view of the axle apparatus of FIG. 11 with a schematically shown bicycle fork in the released state.

FIG. 17 is a perspective view of the bicycle fork schematically shown and shortened and can advantageously be used with a bicycle axle assembly according to the invention.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

The following reference numerals are used in the description of the examples set forth herein:
10 Bicycle wheel holder
11 Holder end (closed)
12 Holder end (open)
13 Passage
14 Open bore
15 Stop for hub
16 Countersink (stop and holder for thrust piece 51)
18 End face (of the countersink 16)
110 Bicycle wheel holder (fork)
111 Holder end (also dropout, closed)
112 Holder end (also dropout, can be formed so as to be open, also dropout, closed)
113 Fork leg (tube)
114 Fork leg (tube)
115 Insertion piece (stop for collar 133)
120 Counter-holder
121 Flange (in the case of slotted end section)
122 End section
123 Flange (for support on the holder end 112)
124 Cylinder section
130 Axle (can be formed as a full-floating axle)
131 Slotted end section
132 End section (with greater external diameter)
133 Stop member (collar)
134 Cylinder section
140 Clamping axle
141 Clamping axle head
142 Clamping axle section
143 Clamping disc
144 Fast-action clamping device
145 Clamping lever
170 Spring device (helical spring)
210 Bicycle wheel holder (fork)
211 Holder end (also dropout, closed)
212 Holder end (also dropout, can be formed so as to be open, also dropout, closed)
213 Fork leg (tube)
214 Fork leg (tube)
215 Insertion piece (stop for collar 233)
220 Counter-holder
222 Disc section
223 Flange (for support on the holder end 212)
230 Axle (can be formed as a full-floating axle)
231 Slotted end section
232 End section (with greater external diameter)
233 Stop member (collar)
234 Cylinder section
240 Clamping axle
241 Clamping axle head
242 Clamping axle section
243 Adjusting nut (or clamping disc)
244 Fast-action clamping device
245 Clamping lever
270 Spring device (helical spring)
310 Bicycle wheel holder (fork)
311 Holder end (also dropout, closed)
312 Holder end (also dropout, can be formed so as to be open, also dropout, closed)
313 Fork leg (tube)
314 Fork leg (tube)
320 Link
322 Cylinder section
323 Flange (for support on the holder end 311)
330 Axle (can be formed as a full-floating axle)
331 End section (with smaller external diameter)
332 End section
333 Stop member (collar)
334 Flange
340 Clamping axle
344 Fast-action clamping device
345 Clamping lever
360 Clamping element
370 Spring device (helical spring)

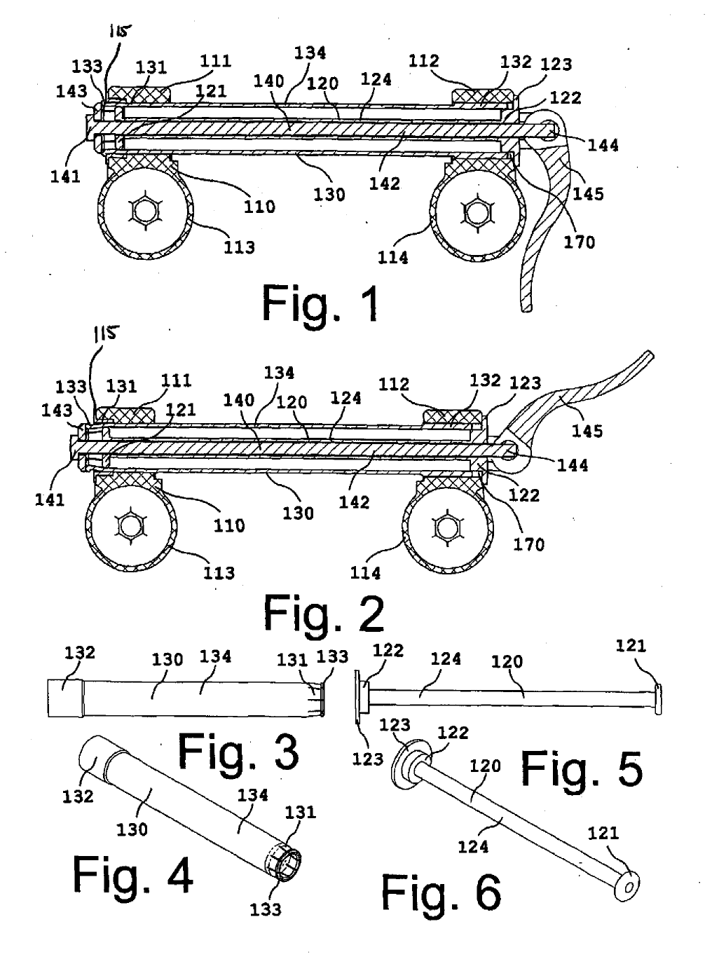

Described now are exemplary embodiments of the present invention. Referring now to the figures of the drawings in detail and first, particularly to FIGS. 1 to 6, there is shown a first exemplary embodiment of a first embodiment of a bicycle axle assembly according to the invention.

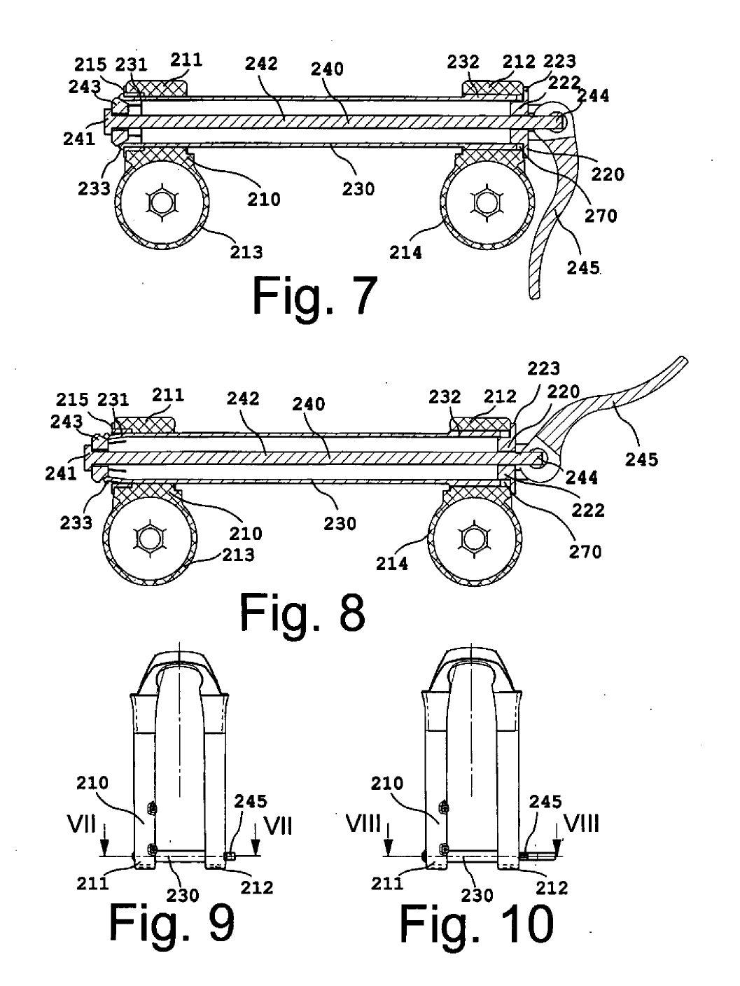

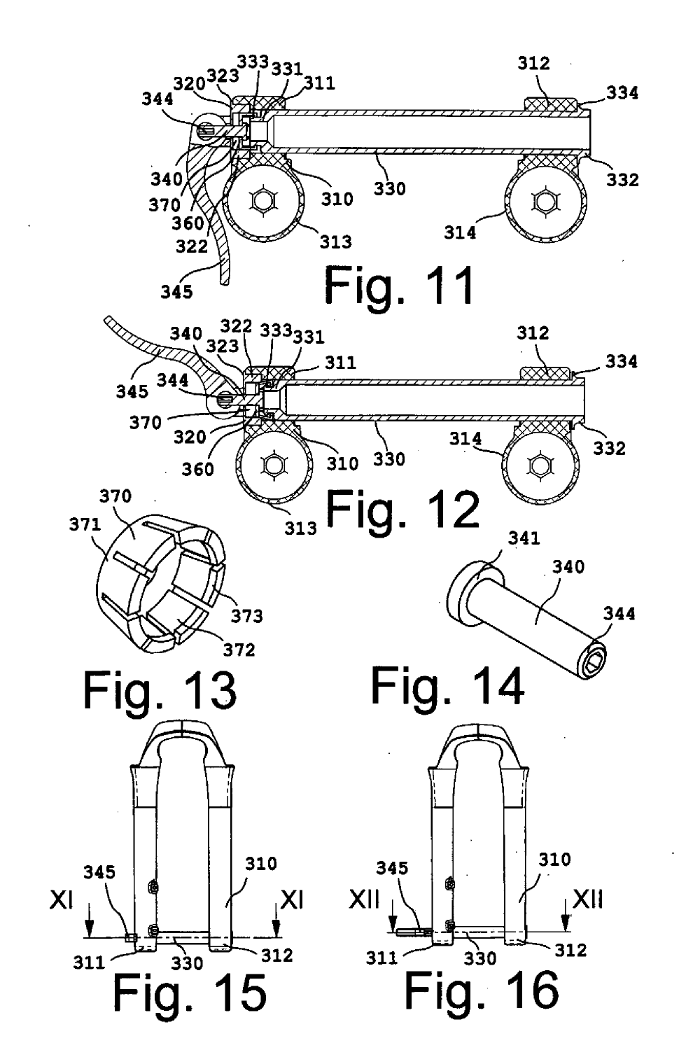

FIGS. 7 to 10 show a second embodiment of a bicycle axle assembly according to the invention and FIGS. 11 to 16 show a third embodiment of a bicycle axle assembly according to the present invention.

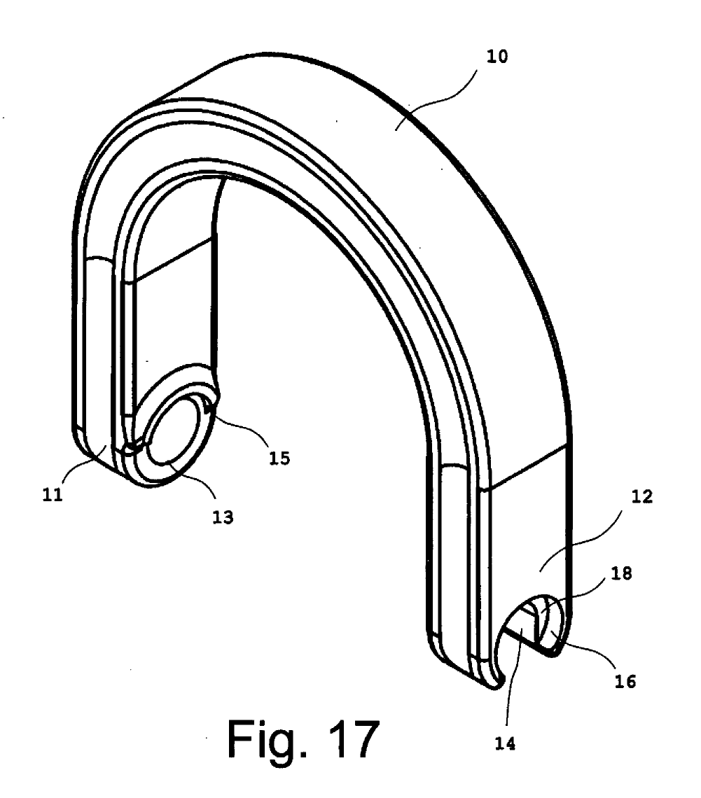

FIG. 17 shows a schematically represented bicycle axle holder which can advantageously be combined with embodiments of the invention shown in FIGS. 1 to 16.

Common to all three working examples is the principle that expansion of a slotted component that is supported axially in a collar in the expanded state is first effected by the clamping process. The support is, then, used for producing an axial prestress.

First, the embodiment illustrated in FIGS. 1 to 6 will be described. In the other embodiments, corresponding parts are designated by reference numerals incremented by 100 or 200. Concerning the description of the further embodiments, reference is made to the description of the first embodiment, which is shown in FIGS. 1 to 6, in relation to the corresponding components. The description of the further embodiments will focus on the differences from the first embodiment.

FIG. 1 shows a bicycle axle assembly comprising an axle 130, a clamping axle 140 and a counter-holder 120. The axle 130 is disposed in a bicycle wheel holder 110 (for example, as shown, a fork or a rocker arm or a chainstay of a bicycle), which has a left holder end 111 and a right holder end 112. In the embodiment shown, the holder ends are closed holder ends and the axle 130 is a full-floating axle.

An insertion piece 115, as a stop for the collar 133 of the axle 130, is provided at the left holder end 111.

Since, as shown, the axle 130 has an end section 132 with a greater diameter, the right holder end 112 may also be formed so as to be open, as shown, for example, in FIG. 17, and can have a countersink in which the end section 132 with the greater diameter is secured to prevent it from falling out even when the clamping device is released.

In the embodiment shown, the axle 130 is disposed in a bicycle fork having two closed dropouts 111, 112. The fork legs 113, 114 are shown. The structure of the bicycle fork is known to the person skilled in the art and is also shown, for example, in FIGS. 9 and 10 or 15 and 16.

The axle 130, the clamping axle 140 and the counter-holder 120 are nonrotatable relative to one another and are part of the bicycle axle assembly according to the invention.

The structure of the axle 130 is most clearly evident in FIGS. 3 and 4. The axle 130 has a slotted end section 131 with a collar 133 that is disposed at the end and extends radially outwards. In the released state, the slotted end section 131 is tapered such that the external diameter of the collar is less than or equal to the external diameter of the axle 130. The axle 130 is in the form of a hollow tube that has, on its side opposite the slotted end section, an end section 132 with a greater external diameter. A cylinder section 134 that serves for receiving a hub of a running wheel, which hub is not shown, runs between the two end sections 131, 132, which are disposed in holder ends of a bicycle holder on assembly.

The axle 130 may be in the form of a full-floating axle. Alternatively, for assembly, the axle may also be inserted only partly if, for example, a bicycle holder 10, as shown in FIG. 17, is used.

The structure of the counter-holder 120 is most clearly evident in FIGS. 5 and 6. The counter-holder has a flange 121 that, in the assembled bicycle axle assembly, is disposed inside the slotted end section 131 of the axle. At its other end, the counter-holder 120 has an end section 122 with a flange 123 for support on the holder end 112. The end section 122 is connected to the flange 121 via a cylinder section 124 in which the clamping axle 140 is disposed in the case of the assembled bicycle axle assembly, as can be seen in FIGS. 1 and 2.

The clamping axle 140 has a clamping axle head 141 with which the clamping disc 143 is secured axially on the clamping axle 140, which clamping disc 143 engages the slotted end section 131 of the axle 130 on tensioning of the clamping device. The clamping axle 140 extends with its clamping axle section 142 through the counter-holder 120. A fast-action clamping device 144 that has a clamping lever 145 and is disposed and formed in a manner known to the person skilled in the art is provided on the side opposite the clamping axle head 141.

Instead of the clamping axle head 141 and the clamping disc 143, it would also be possible to provide an adjusting nut on the clamping axle 140, the position of which can be axially secured, for example, by a locking device. This embodiment has the advantage that easy presetting of the clamping force of a fast-action clamping device can be effected.

A spring device 170 which is not shown separately and which, for example, is in the form of a pressure spring is disposed between the flange 123 and the end section 132 of the axle 130. Only the position of the spring device is indicated by the reference numeral 170.

The axial position of the axle 130 is defined in that the collar formed on the slotted end section 131 is axially supported on the holder end 111.

The collar thus forms a part of a stop member of a stop device which is formed in such a way that it secures the axle 130 in the axial direction in the clamped state of the clamping device.

In particular, the collar disposed at the end of the slotted end section forms a stop of the stop device, which stop is springy in the radial direction.

The clamping process takes place as follows: the axle 130 is pushed into position. Thereafter, the clamping lever 145 is actuated. The slotted end section 131 of the axle 130 widens by virtue of the fact that the left flange 121 of the counter-holder 120 penetrates more deeply into the slotted end section 131 of the axle 130. As a result, the collar is forced outwards and can be axially supported on the holder end 111. On continuation of the clamping process by further actuation of the clamping lever 145, the two holder ends of the fork are axially tightened against one another.

The bicycle axle assembly is thus formed such that the stop formed to be springy in the radial direction secures the axle in the axial direction in the clamped state of the clamping device and releases the axle in the axial direction in the released state of the clamping device.

When the clamping lever 145 is opened, the axle 130 is released. To ensure that the counter-roller 120 and the axle 130 are pushed back towards one another again on opening, a spring device 170 is provided that clamps the axle 130 on the end section 132 away from the flange 123 so that the slotted end section 131 can return to its released starting position in which the collar advantageously has at most the same external diameter as the axle 130. As a result, easy removal of the axle 130 is permitted.

The embodiment of the invention shown in FIGS. 7 to 10 has an axle 230 which corresponds to the axle 130 shown in FIGS. 3 and 4 and belonging to the embodiment of the invention that is shown in FIGS. 1 to 6.

The difference in the embodiment shown in FIGS. 7 to 10 lies substantially in that, instead of the counter-holder 120, a short counter-holder disposed and formed only on one side and an adjusting nut 243 that performs the function of the flange 121 are provided: on clamping, the adjusting nut 243 is introduced into the slotted end section 231 of the axle 230 and thereby widens the slotted end section 231. Instead of an adjusting nut 243, it is also possible to provide a clamping disc that is secured on the clamping axle head and is advantageously formed to taper in a manner corresponding to the adjusting nut 243.

As in the first embodiment, the axle 230 is supported on the holder end of the bicycle wheel holder, with the result that the position of the axle 230 is defined. In this embodiment, it must be ensured that the spring of the spring device 270 is sufficiently strong so that the slotted end section 231 of the axle 230 is first expanded before the slotted end section 231 moves towards the counter-holder 215 that is formed in the dropout 211.

Otherwise, the embodiment corresponds to the embodiment of FIGS. 1 to 6, the description of which is incorporated by reference here. The corresponding components are designated by reference numerals incremented by 100.

FIGS. 11 to 16 show a third embodiment of a bicycle axle assembly according to the present invention.

The bicycle axle assembly according to the invention is disposed in a bicycle wheel holder 310 having a left holder end 311 (also dropout) and a right holder end 312 (also dropout). The bicycle wheel holder 310 is a fork having two fork legs 313, 314 in the embodiment shown.

The axle 330, which may be in the form of a full-floating axle, has an end section 331 with a smaller external diameter, on which a collar 333 is disposed as a stop member. In contrast to the other embodiments, the collar 333 is not disposed in a radially springy manner but is disposed in a fixed manner on the axle 330. The axle is held with its main section of normal diameter in the left holder end 311. The end section with the smaller external diameter extends in the holder end 311. The other end section 332 is held in the other holder end 312 and is axially secured with the flange 334.

The stop member that is disposed in a radially springy manner and cooperates with the collar 333 as a stop device is formed by a clamping element 360 that has a collar that is directed radially inwards and is spring-mounted, as shown in FIGS. 11 and 12, and has a greater circumference in the released state. On tightening, the clamping element 360 is drawn into a link 320 that has a cylinder section 322 and is supported with a flange 323 on the holder end 311. The cylinder section 322 compresses the clamping element 360 such that the collar of the clamping element 360 engages the collar 333 of the axle.

In this embodiment, the clamping axle 340 is very short, resulting in high axial rigidity. Moreover, it is possible to reduce the weight because the clamping axle need not extend through the total axle. This is the case because the stop device is disposed on the same side as the fast-action clamping device 344.

In this embodiment, a spring device 370 (for example, a helical spring disposed as a pressure spring) is provided between the link 320 and the clamping element 260.

This embodiment has the advantage that, on removal of the running wheel, the fast-action clamping device 344, including the link 320 and the clamping element 360, remains on the bicycle wheel holder because the axle 330 is pulled out of the clamping element 360 and can be removed with the running wheel but without said components.

The advantage of this embodiment is that the axle 330 can be formed as a simple turned part, which is more economical for production.

Otherwise, the embodiment corresponds to the preceding embodiments of the invention, the description of which is incorporated by reference here. The corresponding components are designated by reference numerals incremented by 100 and 200, respectively.

With reference to FIG. 17, a bicycle wheel holder 10 is described that can advantageously be used with the embodiments of the bicycle axle assembly according to the invention.

The bicycle wheel holder 10 has a closed holder end 11 and an open holder end 12. As can best be seen in FIG. 17, the closed holder end 11 has a passage 13 with a stop 15 for the hub not shown in the figures. The open holder end 12 has an open bore 14 in which a countersink 16 is provided that serves as a stop and holder for that end section of the axle having a greater diameter.

In the released state, the end section of greater diameter secures the running wheel due to its greater diameter, which is greater than the external diameter of the axle 130 and the diameter of the open holder end 12, to prevent it from falling out, because, in the released state of the fast-action clamping apparatus, the end section of greater diameter does not project completely out of the countersink 16 and is supported on the circumferential wall of the countersink 16.

The working examples of the invention that are shown in FIGS. 1 to 16 comprise an axle having a fast-action clamping device. A hub for a running wheel is not shown. It is clear that, according to the invention, the bicycle axle assembly may comprise the hub. Of course, the bicycle axle assembly according to the invention can also be used with commercially available hubs without departing from the scope of protection of the invention, because the bicycle axle assembly is not marketable without a hub.

The hub may have a bearing section on each of the two sides. Usually, the hub is mounted by ball bearings on the axle. A cylinder section that, together with the surface of the axle, defines a cavity extends between the bearing sections.

A loss prevention device in the form of two O-rings that are disposed in the cavity on the axle is advantageously provided in embodiments in which the axle is held in an open and a closed holder end.

Furthermore, a spring device that prestresses the axle in the direction of the clamping lever end, i.e., away from the closed holder end, can be disposed in the cavity.

A stop for the loss prevention device can be provided at an axial end of the cavity and a stop for the spring device can be provided at the other end of the cavity. The spring device can be disposed between the stop and the loss prevention device.

An assembly of the spring device which can be formed as a pressure spring, between the stop and the loss prevention device, has the advantage that, after opening the fast-action clamp and pulling the axle out of the closed holder end, the axle inside the hub is pressed by the spring device into a certain position, i.e., a position in which the loss prevention device rests against the stop. As a result, the axle in the hub reaches an end position so that it is possible to concentrate on the introduction of the hub and of the brake, which is not shown, during installation and removal of the running wheel, because the axle is not in the way on the other side. To install the axle again, the axle must be introduced with its end into the holder end against the force of the spring device.

It is clear that alternative and equivalent solutions obvious to the person skilled in the art on studying the documents should also be within the scope of protection of the present application. For example, alternative configurations of the spring device are conceivable. For example, the spring device could prestress the clamping axle 140, 240, 340 relative to the axle 130, 230, 330.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A bicycle axle assembly to be used with a bicycle wheel axle holder, the bicycle axle assembly comprising
an axle formed as a carrier part for a wheel hub and defining an axial direction and a radial direction;
a clamping device for clamping the bicycle axle assembly in the bicycle wheel axle holder, the clamping device having a clamped state and a released state;
a stop device operable to secure the axle in the axial direction in the clamped state of the clamping device, the stop device having a stop member comprising a stop that:
is springy in the radial direction;
secures the axle in the axial direction in the clamped state of the clamping device; and
releases the axle in the axial direction in the released state of the clamping device.

2. The bicycle axle assembly according to claim 1, wherein the stop member comprises a slotted end section of the axle.

3. The bicycle axle assembly according to claim 2, wherein the slotted end section of the axle tapers outwards relative to the axle.

4. The bicycle axle assembly according to claim 2, wherein the slotted end section has:
an axial end; and
a collar extending radially outwards on the axial end of the slotted end section.

5. The bicycle axle assembly according to claim 4, wherein:
the axle has a section adjacent the slotted end section and the section has a given external diameter; and
the collar has an external diameter in the released state less than or equal to the given external diameter of the section.

6. The bicycle axle assembly according to claim 2, wherein:
the axle has a second end section opposite the slotted end section; and
the second end section has an external diameter greater than an external diameter of the section adjacent the slotted end section.

7. The bicycle axle assembly according to claim 1, wherein the clamping device has a clamping axle disposed coaxially with the axle.

8. The bicycle axle assembly according to claim 1, wherein the clamping device is a fast-action clamping device.

9. The bicycle axle assembly according to claim 1, further comprising:
a counter-holder cooperating with the clamping device; and
a spring device operable to clamp the counter-holder away from the axle.

10. The bicycle axle assembly according to claim 1, wherein:
the bicycle axle assembly further comprises a counter-holder;
the bicycle wheel axle holder has a holder end; and
the counter-holder comprises:
a flange for support on the holder end of the bicycle wheel axle holder; and
an abutment region for the clamping device.

11. The bicycle axle assembly according to claim 10, wherein:
the stop member comprises a slotted end section of the axle;
the axle has a second end section opposite the slotted end section;
the flange of the counter-holder is at the second end section.

12. The bicycle axle assembly according to claim 10, further comprising a spring device operable to clamp the counter-holder away from the axle, the spring device being a pressure spring disposed between the counter-holder and the axle.

13. The bicycle axle assembly according to claim 2, wherein:
the bicycle wheel axle holder has a holder end;
the bicycle axle assembly further comprises:
a flange for support on the holder end of the bicycle wheel axle holder; and
a counter-holder; and
the counter-holder has a further flange disposed in a region of the slotted end section of the axle.

14. The bicycle axle assembly according to claim 13, wherein:
the clamping device has a clamping axle disposed coaxially with the axle; and
the flange and the further flange are connected to a section of the axle in which the clamping axle runs.

15. The bicycle axle assembly according to claim 13, wherein the further flange is operable to widen the slotted end section of the axle in the clamped state of the clamping device.

16. The bicycle axle assembly according to claim 1, wherein:
the stop member comprises a slotted end section of the axle;
the clamping device has a clamping axle disposed coaxially with the axle; and
the clamping device has a nut disposed on the clamping axle and, at least in the clamped state, the nut engages the slotted end section of the axle.

17. The bicycle axle assembly according to claim 16, wherein the nut has an external diameter tapering in a direction of the axle.

18. The bicycle axle assembly according to claim 17, wherein the stop member of the stop device has a clamping element with a collar formed radially inwards.

19. The bicycle axle assembly according to claim 18, wherein:
the stop member has a collar;
the axle has an given external diameter and an end section with an external diameter smaller than the given external diameter; and
the end section has a radially outwardly projecting collar serving as a counter-stop for the collar of the stop member.

20. The bicycle axle assembly according to claim 18, wherein:
the clamping device has a link operable to, on clamping of the clamping device, move in a direction of the clamping element and move the stop radially inwards.

21. The bicycle axle assembly according to claim 20, further comprising a spring device operable to clamp the link away from the clamping element.

22. The bicycle axle assembly according to claim 1, wherein the axle is tubular.

23. The bicycle axle assembly according to claim 1, the axle is a full-floating axle.

24. The bicycle axle assembly according to claim 1, wherein the axle has a given external diameter and an end section with a diameter greater than the given external diameter.

25. The bicycle axle assembly according to claim 7, wherein the clamping axle is adjustable in length.

26. The bicycle axle assembly according to claim 7, wherein the clamping axle is formed in at least two parts.

27. The bicycle axle assembly according to claim 7, wherein the clamping axle has:
an axle section with threaded blind hole; and
an adjusting nut screwed onto the axle section.

28. The bicycle axle assembly according to claim 7, wherein the clamping axle is non-rotatable with respect to the axle.

29. The bicycle axle assembly according to claim 1, wherein:
the bicycle axle assembly further comprises a counter-holder;
the clamping device has a clamping axle disposed coaxially with the axle; and
the counter-holder is nonrotatable with respect to at least one of the axle and the clamping axle.

30. The bicycle axle assembly according to claim 7, wherein:
the axle has a rotation prevention section; and
the clamping axle has a rotation prevention section cooperating with the rotation prevention section of the axle.

31. The bicycle axle assembly according to claim 30, wherein:
the rotation prevention section of the axle has at least one of a polygon socket and an internal multi-tooth profile; and
the rotation prevention section of the clamping axle has at least one of an external polygon and an external multi-tooth profile.

32. The bicycle axle assembly according to claim 1, further comprising:
a hub disposed on the axle, the hub and the axle defining a cavity therebetween; and
a loss prevention device captively holding the axle in the hub and disposed in the cavity.

33. The bicycle axle assembly according to claim 32, wherein the loss prevention device is at least one O-ring on the axle.

34. The bicycle axle assembly according to claim 8, wherein the axle has a fast-action clamping end and further comprising a spring device that prestresses the axle in a direction of the fast-action clamping end.

35. The bicycle axle assembly according to claim 34, further comprising:
a hub disposed on the axle, the hub and the axle defining a cavity therebetween; and
a loss prevention device captively holding the axle in the hub and being disposed in the cavity, the spring device being disposed between the hub and the loss prevention device.

36. The bicycle axle assembly according to claim 1, further comprising a bicycle wheel axle holder having two holder ends shaped to hold the axle, a first holder end being a closed holder end and a second holder end being an open holder end.

37. The bicycle axle assembly according to claim 36, further comprising a hub disposed on the axle, at least one of the closed holder end and the open holder end having a stop for the hub.

38. The bicycle axle assembly according to claim 36, wherein at least one of the open holder end and the closed holder end has a countersink.

39. The bicycle axle assembly according to claim 36, wherein the bicycle wheel axle holder is part of at least one of a bicycle fork, a bicycle rocker arm, and a bicycle chainstay.
